(19) United States
(12) Patent Application Publication
(10) Pub. No.: US 2021/0042674 A1
(43) Pub. Date: Feb. 11, 2021

(54) SYSTEM AND METHOD FOR PROVIDING FINANCIAL MODELLING

(71) Applicant: Fei Mei Chan, New York, NY (US)

(72) Inventor: Fei Mei Chan, New York, NY (US)

(21) Appl. No.: 16/536,849

(22) Filed: Aug. 9, 2019

(51) Int. Cl. G06Q 10/06

(52) U.S. Cl. CPC G06Q 10/0637; G06Q 10/067

(57) ABSTRACT

A financial modelling system and method are disclosed. The system is configured to receive financial data of a user and a request comprising financial market data including at least one of current value or future value of at least one instrument, generic financial update request, or generic financial forecast request. An action priority list is generated based on the user financial data and the financial market data. A first action item from the action priority list is matched with at least two service providers for providing a service related to the at least first action item based on the user financial data and financial market data. On acceptance between the user and at least one service provider to initiate the service, transfer of at least a partial amount of an entire confirmed debt amount from a payment agent of the user into an accepted service provider payment agent is triggered.

### BACKGROUND OF THE INVENTION

### A. Technical Field

The present invention generally relates to financial management, and more specifically relates to a system and method to provide a feasible and optimal financial model or financial plan to manage user's financial goal or financial health.

### B. Description of Related Art

Financial planning helps an individual to plan for the future and take better control of financial goals by helping to set realistic plans, evaluate alternatives and take effective measures. Financial planning involves recording all of the individual's incomings and outgoings, and gives a breakdown of spending of each week, month or year across the following broad categories: household, transport, food and drinks, leisure, shopping, health and beauty, education and profession, family and friends, taxation, financial commitments, etc. Then based on the analysis, a financial model plan is created to achieve the financial goal. Traditionally, many individuals have entrusted their financial plans to personal financial advisors.

Although the financial advisor is a valuable ingredient in helping the individual achieve his prospective financial goals, financial advisors can be very expensive. In fact, individuals who traditionally use a personal fund manager or advisor generally have portfolios in excess of several million dollars. The advisor spends a great deal of his expensive time in ascertaining the user's goals, market attitude, preferences and risk tolerance. The advisor then accumulates all the financial information regarding the individual and model his investment portfolio. A thorough investigation is required in order to dispense good advice taking the individual's tax liability, life style, expenses or unforeseen events into account as well as the user's financial goals. This process is expensive and thus an unavailable option for the majority of individuals.

But today, more and more individuals are handling their financial destiny on their own and playing a more active role in planning and achieving their financial goals. Increasingly, these individuals rely on computer-based systems and tools that organize their financial assets and liabilities and further provide them with a summary of their financial health. However, financial modeling systems require a great deal of data input and users become discouraged by the tediousness of the task.

Therefore, there is a need for a system and method to provide a feasible and optimal financial model or financial plan to manage user's financial goal or financial health, utilizing a simple process.

### SUMMARY OF THE INVENTION

A financial modeling system and method is disclosed. In one embodiment, the system comprises one or more processors, and a memory coupled to the one or more processors, wherein the memory stores set of program modules executable by the one or more processors to implement a financial modeling platform. The program modules include a profile module, a requesting module, an action priority generator, a bidding module, a matching module and a payment module. The profile module is configured to receive financial data of a user to create a user profile, wherein the financial data is at least one of financial health attributes or financial goal attributes. The requesting module is configured to receive a request comprising financial market data to design a financial model, wherein the financial market data comprises at least one of current value of at least one instrument, future value of at least one instrument, generic financial update request, or generic financial forecast request.

The action priority generator is configured to generate an action priority list based on the user financial data and the financial market data, wherein the action priority list comprises one or more action items. The list comprising one or more action items are provided in a specific order to be implemented to prevent one or more financial risk events incurring to at least one of financial health attributes or financial goal attributes. The bidding module is configured to enable one or more service providers to bid for an opportunity to provide a service or a financial product related to one or more action items. The matching module in communication with the bidding module is configured to match at least a first action item from the action priority list with at least two service providers for providing a service related to the at least first action item based on the user financial data and financial market data. The payment module, on acceptance between the user and at least one service provider to initiate the service, is configured to trigger transfer of at least a partial amount of an entire confirmed debt amount from a payment agent of the user into an accepted service provider payment agent.

In one embodiment, a method for providing a financial model, incorporated in a system comprising, one or more processors, and a memory coupled to the one or more processors, wherein the memory stores set of program modules executable by the one or more processors to implement a financial modeling platform, is disclosed. The method comprises a step of: receiving at the processor, via a profile module, financial data of a user to create a user profile, wherein the financial data is at least one of financial health attributes or financial goal attributes.

The method further comprises a step of: receiving at the processor, via a requesting module, a request comprising financial market data to design a financial model, wherein the financial market data comprises at least one of current value of at least one instrument, future value of at least one instrument, generic financial update request, or generic financial forecast request. The method further comprises a step of: generating at the processor, via an action priority generator, an action priority list based on the user financial data and the financial market data, wherein the action priority list comprises one or more action items. The method further comprises a step of: enabling at the processor, via a bidding module, service providers to bid for an opportunity to provide a service or a financial product related to one or more action items.

The method further comprises a step of: matching at the processor, via a matching module, at least a first action item from the action priority list with at least two service providers for providing the service related to the at least first action item based on the user financial data and financial market data. The method further comprises a step of: triggering at the processor, via a payment module, on acceptance between the user and at least one service provider to initiate the service, transfer of at least a partial amount of an entire confirmed debt amount from a payment agent of the user into an accepted service provider payment agent.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The embodiments herein will be better understood from the following detailed description with reference to the drawings, in which:

FIG. 1 exemplarily illustrates a block diagram of an environment implemented according to an embodiment of the present invention.

FIG. 2 exemplarily illustrates a block diagram of financial modeling server according to an embodiment of the present invention.

FIG. 3 exemplarily illustrates a flowchart of financial modeling method in an embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

A financial modelling system and method is disclosed. The financial modeling system configured to provide a feasible and optimal financial model or financial plan to manage user's financial goal or financial health. The financial modeling system configured to enable a user to execute the financial model or plan. The financial model comprises a list having one or more financial action items one or more action items based on a user financial data and a financial market data. The list comprising one or more action items are provided in a specific order to be implemented to prevent one or more financial risk events incurring to at least one of financial health attributes or financial goal attributes. The financial modelling system and method is implemented in a computing system environment.

An example of the computing system environment is disclosed. The computing system environment is not intended to suggest any limitation as to the scope of use or functionality of the system and method described herein. Neither should the computing environment be interpreted as having any dependency or requirement relating to any one or combination of components illustrated in the exemplary operating environment.

Embodiments of the disclosure are operational with numerous other general purpose or special purpose computing system environments or configurations. Examples of well-known computing systems, environments, and/or configurations that may be suitable for use with the systems and methods described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The embodiments of the disclosure may be described in the general context of computer-executable instructions, such as program modules, being executed by a computer. Generally, program modules include routines, programs, objects, components, data structures, etc. that perform particular tasks or implement particular abstract data types. The systems and methods described herein may also be practiced in distributed computing environments where tasks are performed by remote processing devices that are linked through a communications network. In a distributed computing environment, program modules may be located in both local and remote computer storage media including memory storage devices. Tasks performed by the programs and modules are described below and with the aid of figures. Those skilled in the art can implement the exemplary embodiments as processor executable instructions, which can be written on any form of a computer readable media in a corresponding computing environment according to this disclosure.

Components of computer may include, but are not limited to, a processing unit, a system memory, and a system bus that couple various system components including the system memory to the processing unit. The system bus may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer includes a variety of computer readable media. Computer readable media can be any available media that can be accessed by computer and includes both volatile and non-volatile media, removable and non-removable media. By way of example, and not limitation, computer readable media may include computer storage media and communication media. Computer storage media includes both volatile and non-volatile, removable and non-removable media implemented in any method or technology for storage of information such as computer readable instructions, data structures, program modules or other data. Computer storage media includes, but not limited to, Random Access Memory (RAM), Read-Only Memory (ROM), Electrically Erasable Read-Only Memory (EEPROM), flash memory or other memory technology, Compact Disk Read-Only Optical Memory (CD-ROM), digital versatile disks (DVD) or other optical disk storage, magnetic cassettes, magnetic tape, magnetic disk storage or other magnetic storage devices, or any other medium which can be used to store the desired information and which can be accessed by computer.

Communication media embodies one or more of computer readable instructions, data structures, program modules, and the like, and/or other data in a modulated data signal such as a carrier wave or other transport mechanism, and may include any known information delivery media consistent with this disclosure. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory includes computer storage media in the form of volatile and/or non-volatile memory such as read only memory (ROM) and random-access memory (RAM). A basic input/output system (BIOS), containing the basic routines that help to transfer information between elements within computer, such as during start-up, may be stored in ROM. RAM may contain data and/or program modules that are readily accessible by a processing unit 120. By way of example, and not limitation, such data and/or program modules may include an operating system, application programs, other program modules, and program data.

The computer may also include other removable/non-removable volatile/non-volatile computer storage media. By way of example only, a hard disk drive that reads from or writes to non-removable, non-volatile magnetic media, a magnetic disk drive that reads from or writes to a removable, non-volatile magnetic disk, and an optical disk drive that reads from or writes to a removable, non-volatile optical disk such as a CD ROM or other optical media. Other removable/non-removable, volatile/non-volatile computer storage media that can be used in the exemplary operating environment include, but are not limited to, magnetic tape cassettes, flash memory cards, digital versatile disks, digital video tape, solid state RAM, solid state ROM, and the like. The hard disk drive may be connected to the system bus through a non-removable memory interface, and magnetic disk drive and optical disk drive may be connected to the system bus by a removable memory interface.

The drives and their associated computer storage media provide storage of computer readable instructions, data structures, program modules and other data for the computer. For example, hard disk drive disclosed stores operating system, application programs, other program modules, and program data. Each of the storing operating system, the application programs, the other program modules, and the program data may be the same as or different from the operating system, the application programs, the other program modules, and the program data described hereinabove. The operating system, the application programs, the other program modules, and the program data are given different numbers here to illustrate that, at a minimum, they are different copies.

A user may enter commands and information into the computer through input devices such as a keyboard, a microphone, and a pointing device, such as a mouse, trackball or touch pad. Other input devices (not shown) may include a joystick, game pad, satellite dish, scanner, or the like. These and other input devices may be connected to the processing unit through a user input interface that is coupled to the system bus, but may be connected by other interface and bus structures, such as a parallel port, game port or a universal serial bus (USB). A monitor or other type of display device is also connected to the system bus via an interface, such as a video interface. In addition to the monitor, computers may also include other peripheral output devices such as speakers and printer, which may be connected through an output peripheral interface.

The computer may operate in a networked environment using logical connections to one or more remote computers, such as a remote computer. The remote computer may be a personal computer, a hand-held device, a server, a router, a network PC, a peer device or other common network node, and may include one, more or all of the elements described above relative to the computer. The logical connections include a local area network (LAN) and a wide area network (WAN). It is contemplated that the logical connections may include other networks. These other networks may be included in combination with the LAN and WAN. Such networking environments are commonplace in offices, enterprise-wide computer networks, intranets and the Internet.

When used in a LAN networking environment, the computer is connected to the LAN through a network interface or adapter. When used in a WAN networking environment, the computer includes a modem or other means for establishing communications over the WAN, such as the Internet. The modem, which may be internal or external, may be connected to the system bus via the user input interface, or other appropriate mechanism. In a networked environment, program modules depicted relative to the computer, or portions thereof, may be stored in a remote memory storage device. It will be appreciated that the network connections shown are exemplary and other means of establishing a communications link between the computers may be used.

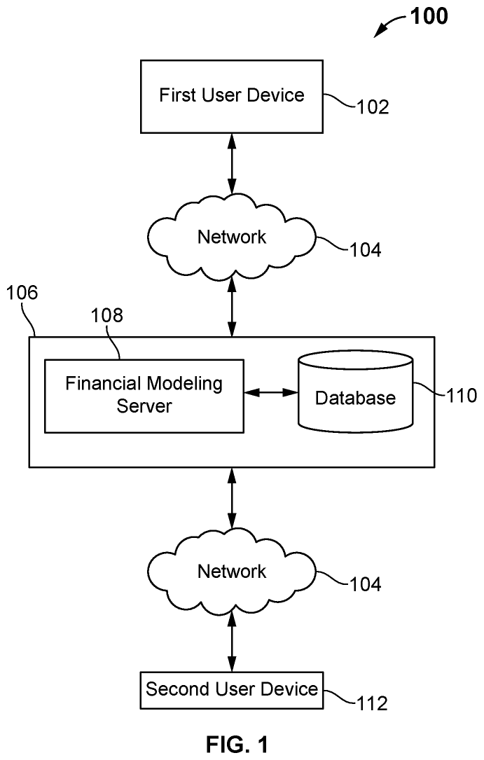

Referring to FIG. 1, a block diagram of an environment 100 implemented in accordance with various embodiments of the present invention is disclosed. Referring to FIG. 1, the environment 100 comprises a financial modeling system 106, a first user device 102 associated with a user, a second user device 112 associated with a service provider and a network 104. The financial modeling system 106 comprises a financial modelling server 108 and a database 110. The first user device 102 and the second user device 112 is in communication with the server 108 via the network 104. In an embodiment, the first user device 102 is at least one of desktop, a laptop, a tablet, a mobile phone, and mobile and/or handheld electronic devices. In an embodiment, the second user device 112 is at least one of desktop, a laptop, a tablet, a mobile phone, and mobile and/or handheld electronic devices. In one embodiment, the network 104 could be Wi-Fi network, WiMax network, and wireless local area network.

In one embodiment, the database 110 may be accessible by the server 108. The database 110 may be integrated into the server 108 or separate from it. In some embodiments, the database 110 resides in the connected server 108 or in a cloud computing service. Regardless of location, the database 110 comprise a memory to store and organize certain data for use by the server 108. The server 108 is incorporated with computer-readable instructions for implementing artificial neural network models.

In some embodiments, the database stores plurality of user related information, user financial data, service provider data, financial marketing data and a financial modeling algorithm. In one embodiment, the financial modelling server 108 is at least one of a general or special purpose computer. The server 108 could be operated as a single computer, which could be a hardware and/or software server, a workstation, a mainframe, a supercomputer, a server farm, and so forth. In some embodiments, the computer could be touchscreen and/or non-touchscreen and adopted to run on any type of OS, such as iOS™, Windows™ Android™, Unix™, Linux™ and/or others.

The system 106 is configured to manage and model personal finances. The system 106 also empowers an individual to plan and forecast their financial future. The system 106 is configured to receive financial data of the user to create a user profile. In one embodiment, the financial data comprises at least one of financial health attributes or financial goal attributes. In another embodiment, the financial data further includes, but not limited to, aggregate cash flow model, an investment target value, a target date for achieving financial goals, or an investment portfolio. The system 106 is further configured to receive a request comprising financial market data to design a financial model, wherein the financial market data comprises at least one of current value of at least one instrument, future value of at least one instrument, generic financial update request, or a generic financial forecast request.

The system 106 is further configured to generate an action priority list based on the user financial data and the financial market data, wherein the action priority list comprises one or more action items. In one embodiment, the list comprising one or more action items are provided in a specific order to be implemented to prevent one or more financial risk events incurring to at least one of financial health attributes or financial goal attributes. In one embodiment, the list comprising one or more action items are provided in a specific order to be implemented for maximizing the wealth of the user.

The system 106 is further configured to generate an action priority list based on the user financial data and the financial market data, wherein the action priority list comprises one or more action items. The system 106 is further configured to enable one or more service providers to bid for an opportunity to provide a service related to one or more action items. The system 106 is further configured to match at least a first action item from the action priority list with at least two service providers for providing a service related to the at least first action item based on the user financial data and financial market data. On acceptance between the user and at least one service provider to initiate the service, the system 106 is configured to trigger transfer of at least a partial amount of an entire confirmed debt amount from a payment agent of the user into an accepted service provider payment agent. The system 106 is further configured to provide dashboard-type periodic reminders for updating profile. The system 106 is further configured to provide dashboard-type visual of lost opportunity from not prioritizing based on generators suggestion. The system 106 is further configured to enable third-party integration for crawling financial-related info or personal info for constructing the profile. This feature provides system-generated profile, versus a user-generated profile, to ensure greater trust in the peer-peer environment.

In one embodiment, the system 106 incorporated with artificial neural network model is configured to generate an action priority list automatically by analysis of data extracts from the database 110. The artificial neural network model is a computing device that processes input using artificial intelligence to produce outputs. In one embodiment, artificial neural network model is trained using previous determinations of financial model. In another embodiment, it is trained by giving it examples of inputs and corresponding outputs. A typical training set may contain many examples. As a result, the network adapts its internal logical structure so that when it is provided with a non-example input it will produce a corresponding output based on its prior training.

The user information in the database 110 is processed through the artificial intelligence and generates the priority list. The list is compared with the data extracts to check of the action priority list conforms to user financial information including user specific financial goals, tracking the user specific financial goals during user account transactions. The artificial intelligence model is configured to enable the system 106 to make appropriate adjustments and assessments based on the progress of the financial goals.

In another embodiment, the artificial neural network model compares predicted results to actual outcomes utilizing predictive analytics. The predictive analytics applies rules through a matching, refinement, and redefining process based on changing conditions, provider specialties, and type of provider. This enables the system 106 to identify a best match of one or more service providers for providing the service related to the at least first action item. Thus, the implementation of artificial neural network model eliminates the need to rely on financial advisors. The artificial neural network models prevent any error/plans that would hinder the progress of achieving user financial goal.

The present invention enables modelling of the reasoning employed by a human expert, in this case a financial advisor, as a computer algorithm that produces the determination. With the ability to extract knowledge directly from text without much manual intervention using artificial intelligence, and speed and memory of computing device provides a feasible and optimal financial model or financial plan to manage user's financial goal or financial health.

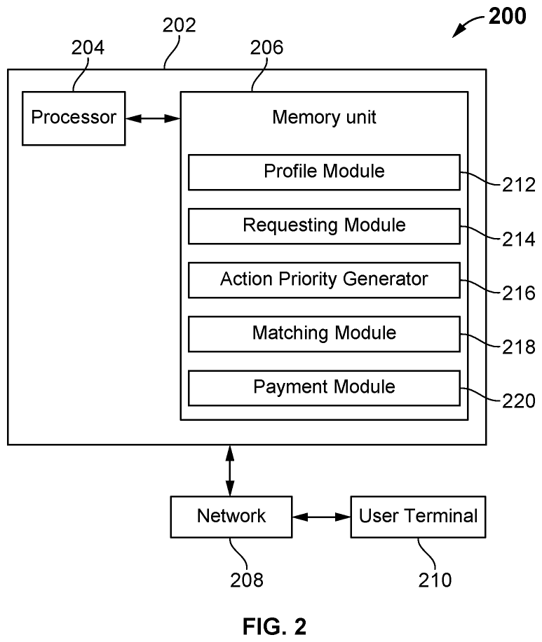

A block diagram 200 of the fund transfer management server 202 or 108 is detailly illustrated in FIG. 2. Referring to FIG. 2, the server 202 comprises a processor 204 and a memory unit 206. The memory unit 206 comprises a set of program modules executable by the processor. The server 202 is configured to utilize machine learning, neural networks or artificial intelligence models. The set of program modules comprises a profile module 212, a requesting module 214, an action priority generator 216, a bidding module 218, a matching module 220, and a payment module 222.

In one embodiment, the user accesses the server 202 utilizing a user terminal 210 via a network 208. In some embodiments, the user terminal 210 is at least anyone of a desktop, a laptop, a tablet, a mobile phone, mobile and/or handheld electronic devices, personnel digital assistants, smart phones, smart televisions, palm tops and phablets. The server 202 is in communication with a database, the database stores information related to the user, user's financial account, user financial data, service provider data, financial marketing data and a financial modeling algorithm.

The profile module 212 is configured to receive financial data of a user to create a user profile, wherein the financial data is at least one of financial health attributes or financial goal attributes. In one embodiment, the financial data further includes, but not limited to, income growth, current account balances, current financial product holdings, current savings rate, an investment target value, a target date for achieving user financial goals, or an investment portfolio. In another embodiment, the profile module 212 is further configured to receive credentials including, but not limited to, first name, last name, email address, phone number and password. The requesting module 214 is configured to receive request comprising financial market data to design a financial model, wherein the financial market data comprises at least one of current value of at least one instrument, future value of at least one instrument, generic financial update request, or generic financial forecast request.

The action priority generator 216 is configured to generate an action priority list based on the user financial data and the financial market data, wherein the action priority list comprises one or more action items. The list comprising one or more action items are provided in a specific order to be implemented to prevent one or more financial risk events incurring to at least one of financial health attributes or financial goal attributes. The Action priority generator 216 comprises the ability to assess user's financial state (assets, liabilities, income, fixed and variable costs) and analyze investment and payoff options available to the user and formulate a plan of action with goal of maximizing wealth. The action priority generator 216 is configured to use a combination of various statistics, artificial intelligence, machine learning, or neural networks to generate the action priority list.

In an example, if employer offers 401(k) plan with or without match, user should prioritize contributions up to the tax-free allowance to take advantage of the tax benefit unless other investment vehicles/payoff options are generating more wealth than the tax benefit. The action priority generator 216 evaluates the investment options for their costs, risks and return potential. In another example, the user has two outstanding debts, which is gathered from the user profile. The user requests for a plan via the requesting module. The action priority generator 216 is configured to assess the interest payments of the two outstanding debts and generate an action priority list based on the user financial data and the financial market data. In the generated list, the action priority generator 216 is configured to give priority to debt outstanding that has the highest burden on user.

The bidding module 218 is further configured to enable one or more service providers to bid for an opportunity to provide a service or a financial product related to one or more action items. This enables the service providers to persuade the user. Also, the bidding module 218 in communication with the matching module 220 helps the user to identify an affordable service provider. For example, the bid could indicate offers, gifts, and discounts. Further, the bid could indicate that a first service provider is willing to provide a service for a first amount and a second service provider is willing to provide the service product for a second amount.

The matching module 220 in communication with the bidding module 218 is configured to match at least a first action item from the action priority list with at least two service providers for providing a service related to the at least first action item based on the user financial data and financial market data. The matching module 220 utilizes a combination of various statistics, artificial intelligence, machine learning, or neural networks for matching operation. The payment module 222, on acceptance between the user and at least one service provider to initiate the service, is configured to trigger transfer of at least a partial amount of an entire confirmed debt amount from a payment agent of the user into an accepted service provider payment agent.

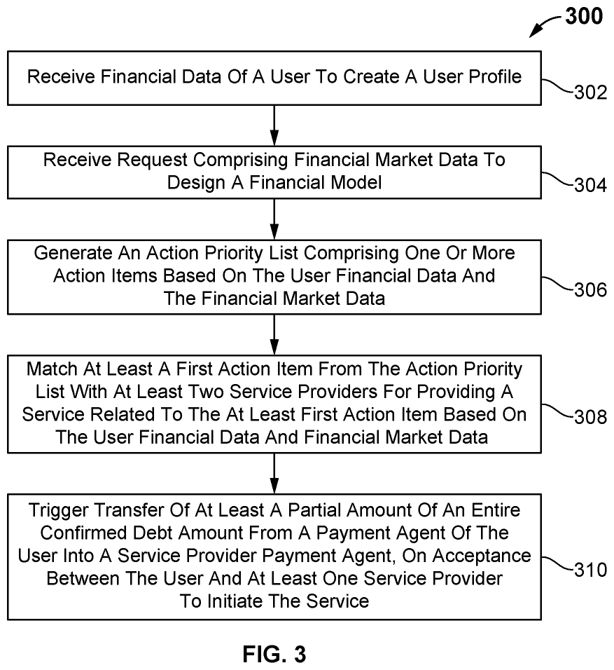

Referring to FIG. 3, a method 300 for providing a financial model or financial model, incorporated in a system comprising, one or more processors, and a memory coupled to the one or more processors, wherein the memory stores set of program modules executable by the one or more processors to implement a financial modeling platform, is disclosed. The method 300 comprises a step 302 of: receiving at the processor, via a profile module, financial data of a user to create a user profile, wherein the financial data is at least one of financial health attributes or financial goal attributes. The method 300 further comprises a step 304 of: receiving at the processor, via a requesting module, request comprising financial market data to design a financial model, wherein the financial market data comprises at least one of current value of at least one instrument, future value of at least one instrument, generic financial update request, or generic financial forecast request.

The method 300 further comprises a step 306 of: generating at the processor, via an action priority generator, an action priority list based on the user financial data and the financial market data, wherein the action priority list comprises one or more action items. The list comprising one or more action items are provided in a specific order to be implemented to prevent one or more financial risk events incurring to at least one of financial health attributes or financial goal attributes. The method 300 further comprises a step 308 of: enabling at the processor, via a bidding module, one or more service providers to bid for an opportunity to provide a service or a financial product related to one or more action items. The method 300 further comprises a step 310 of: matching at the processor, via a matching module, at least a first action item from the action priority list with at least two service providers for providing the service related to the at least first action item based on the user financial data and financial market data. The method 300 further comprises a step 312 of: triggering at the processor, via a payment module, on acceptance between the user and at least one service provider to initiate the service, transfer of at least a partial amount of an entire confirmed debt amount from a payment agent of the user into an accepted service provider payment agent.

Advantageously, the financial modeling system configured to provide a feasible and optimal financial model or financial plan to manage user's financial goal or financial health. The financial modelling system improves the processor by lowering consumption, and improving speed accuracy with a post-processor or optimizer. The financial modeling system configured to enable a user to execute the financial model or plan. The financial model comprises a list having one or more action items in a specific order to be implemented to prevent one or more financial risk events incurring to at least one of financial health attributes or financial goal attributes. The financial modeling platform is a comprehensive tool for financial management throughout the entire lifecycle. The financial modeling system is a financial planner that also provide basic finance advice. The financial modelling system have the capability to model present value, future value, interest calculations, amortizations, which debt to pay off first for minimum interest payment, investment modeling, tax planning, investment portfolios, etc.

Although a single embodiment of the invention has been illustrated in the accompanying drawings and described in the above detailed description, it will be understood that the invention is not limited to the embodiment developed herein, but is capable of numerous rearrangements, modifications, substitutions of parts and elements without departing from the spirit and scope of the invention.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A financial modeling system comprising:
a computing device having,
one or more processors, and
a memory coupled to the one or more processors, wherein the memory stores set of program modules executable by the one or more processors to implement a financial modeling platform, wherein the program module comprises:
a profile module configured to receive financial data of a user to create a user profile, wherein the financial data is at least one of financial health attributes or financial goal attributes;
a requesting module configured to receive request comprising financial market data to design a financial model, wherein the financial market data comprises at least one of current value of at least one instrument, future value of at least one instrument, generic financial update request, or generic financial forecast request;
an action priority generator configured to generate an action priority list based on the user financial data and the financial market data, wherein the action priority list comprises one or more action items;
a matching module configured to match at least a first action item from the action priority list with at least two service providers for providing a service related to the at least first action item based on the user financial data and financial market data, and
a payment module, on acceptance between the user and at least one service provider to initiate the service, configured to trigger transfer of at least a partial amount of an entire confirmed debt amount from a payment agent of the user into an accepted service provider payment agent.

2. The financial modeling system of claim 1, wherein the list comprising one or more action items are provided in a specific order to be implemented to prevent one or more financial risk events incurring to at least one of financial health attributes or financial goal attributes.

3. The financial modeling system of claim 1, wherein the list comprising one or more action items are provided in a specific order to be implemented for maximizing the wealth of the user.

4. The financial modeling system of claim 1, wherein the financial data includes an aggregate cash flow model, an investment target value, a target date for achieving user's financial goals, or an investment portfolio.

5. The financial modeling system of claim 1, further comprises a user device associated the user configured to access the computing device via a network.

6. The financial modeling system of claim 1, wherein the computing device is a server.

7. The financial modeling system of claim 5, wherein the user device is at least one of desktop, laptop, tablet, mobile phone, or handheld electronic device.

8. The financial modeling system of claim 5, wherein the network is at least one of Wi-Fi network, WiMax network, and wireless local area network.

9. A financial modeling system comprising:
a computing device having;
one or more processors, and
a memory coupled to the one or more processors, wherein the memory stores set of program modules executable by the one or more processors to implement a financial modeling platform, wherein the program module comprises:
a profile module configured to receive financial data of a user to create a user profile, wherein the financial data is at least one of financial health attributes or financial goal attributes;
a requesting module configured to receive request comprising financial market data to design a financial model, wherein the financial market data comprises at least one of current value of at least one instrument, future value of at least one instrument, generic financial update request, or generic financial forecast request;
an action priority generator configured to generate an action priority list based on the user financial data and the financial market data, wherein the action priority list comprises one or more action items;
a bidding module configured to enable one or more service providers to bid for an opportunity to provide a service related to one or more action items;
a matching module in communication with the bidding module configured to match at least a first action item from the action priority list with at least two service providers for providing the service related to the at least first action item based on the user financial data and financial market data, and
a payment module, on acceptance between the user and at least one service provider to initiate the service, configured to trigger transfer of at least a partial amount of an entire confirmed debt amount from a payment agent of the user into an accepted service provider payment agent,
wherein the list comprising one or more action items are provided in a specific order to be implemented to prevent one or more financial risk events incurring to at least one of financial health attributes or financial goal attributes.

10. The financial modeling system of claim 9, wherein the list comprising one or more action items are provided in a specific order to be implemented for maximizing the wealth of the user.

11. The financial modeling system of claim 9, wherein the financial data includes an aggregate cash flow model, an investment target value, a target date for achieving financial goals, or an investment portfolio.

12. The financial modeling system of claim 9, further comprises a user device associated the user configured to access the computing device via a network.

13. The financial modeling system of claim 9, wherein the computing device is a server.

14. The financial modeling system of claim 12, wherein the user device is at least one of desktop, laptop, tablet, mobile phone, or handheld electronic device.

15. The financial modeling system of claim 12, wherein the network is at least one of Wi-Fi network, WiMax network, and wireless local area network.

16. A method for providing a financial model, incorporated in a system comprising, one or more processors, and a memory coupled to the one or more processors, wherein the memory stores set of program modules executable by the one or more processors to implement a financial modeling platform, comprising the steps of:
receiving at the processor, via a profile module, financial data of a user to create a user profile, wherein the financial data is at least one of financial health attributes or financial goal attributes;
receiving at the processor, via a requesting module, request comprising financial market data to design a financial model, wherein the financial market data comprises at least one of current value of at least one instrument, future value of at least one instrument, generic financial update request, or generic financial forecast request;
generating at the processor, via an action priority generator, an action priority list based on the user financial data and the financial market data, wherein the action priority list comprises one or more action items;
enabling at the processor, via a bidding module, one or more service providers to bid for an opportunity to provide a service or financial product related to one or more action items;
matching at the processor, via a matching module, at least a first action item from the action priority list with at least two service providers for providing the service related to the at least first action item based on the user financial data and financial market data, and
triggering at the processor, via a payment module, on acceptance between the user and at least one service provider to initiate the service, transfer of at least a partial amount of an entire confirmed debt amount from a payment agent of the user into an accepted service provider payment agent.

17. The financial modeling system of claim 16, wherein the list comprising one or more action items are provided in a specific order to be implemented to prevent one or more financial risk events incurring to at least one of financial health attributes or financial goal attributes.

18. The financial modeling system of claim 16, wherein the list comprising one or more action items are provided in a specific order to be implemented for maximizing the wealth of the user.

19. The financial modeling system of claim 16, wherein the financial data includes an aggregate cash flow model, an investment target value, a target date for achieving financial goals, or an investment portfolio.
